(19) United States
(12) Patent Application Publication
(10) Pub. No.: US 2025/0148352 A1
(43) Pub. Date: May 8, 2025

(54) EXPLAINABLE FEDERATED LEARNING ROBUST TO MALICIOUS CLIENTS AND TO NON-INDEPENDENT AND IDENTICALLY DISTRIBUTED DATA

(71) Applicant: Dell Products L.P., Round Rock, TX (US)

(72) Inventors: Jonathan Mendes De Almeida, Brasília (BR); Eduarda Tatiane Caetano Chagas, Belo Horizonte (BR); Paulo Abelha Ferreira, Rio de Janeiro (BR)

(73) Assignee: Dell Products L.P., Round Rock, TX (US)

(21) Appl. No.: 18/501,784

(22) Filed: Nov. 3, 2023

(51) Int. Cl. G06N 20/00

(52) U.S. Cl. CPC G06N 20/00

(57) ABSTRACT

Techniques are disclosed for explainable federated learning. An example method includes receiving, at a central node, relative importances for a plurality of features input into a machine learning (ML) model usable at an edge node, thereby defining a plurality of feature importances, the central node being configured to communicate with the edge nodes; using, at the central node, an ML algorithm to classify the edge nodes into a number ‘k’ of node groups based on the feature importances; and for each node group among the ‘k’ node groups: generating, at the central node, an ML shared model using the feature importances associated with a selected subset of nodes in the node group; and deploying, at the central node, the shared model to each edge node in the node group.

### FIELD

Example embodiments generally relate to machine learning and machine learning models. More specifically, at least some embodiments relate to systems, hardware, software, computer-readable media, and methods for understanding and identifying the relative importance of features in machine learning models used in edge networks.

### BACKGROUND

Federated Learning (FL) is one of most promising distributed Machine Learning (ML) frameworks to strengthen data privacy and security by training locally and then aggregating local models into a global model without ever sharing their data. Therefore, due to data privacy constraints, it is not possible to guarantee data homogeneity of FL applications, such as within real-world scenarios. Concomitantly, the data heterogeneity issues impair the model's performance and hinder the model's convergence speed (e.g., more training rounds), which makes this problem one of the most relevant challenges in implementing effective FL solutions. Unfortunately communication overhead is a bottleneck of the FL framework.

A critical application such as healthcare is characterized by heterogeneous and geographically dispersed edge nodes in edge networks, and strong constraints in terms of privacy, interpretability, and efficiency (with respect to a machine learning model's performance, local computation, and communication power). Considering the distributed characteristic and strict privacy and communication constraints of FL applications, conventional Explainable Artificial Intelligence (XAI) approaches are not well suited for FL solutions.

### SUMMARY

Techniques are disclosed for explainable federated learning.

In an embodiment, a system includes at least one processing device having a processor coupled to a memory. The at least one processing device can be configured to implement the following steps: receiving, at a central node, relative importances for a plurality of features input into a machine learning (ML) model usable at an edge node, thereby defining a plurality of feature importances, the central node being configured to communicate with the edge nodes; using, at the central node, an ML algorithm to classify the edge nodes into a number ‘k’ of node groups based on the feature importances; and for each node group among the ‘k’ node groups: generating, at the central node, an ML shared model using the feature importances associated with a selected subset of nodes in the node group; and deploying, at the central node, the shared model to each edge node in the node group.

In some embodiments, the feature importances are determined using in-training feature extraction. The in-training feature extraction can be performed using header matrices. The feature importances can be encrypted, and the at least one processing device can be further configured to implement the following steps: receiving, at the central node, model gradients. The feature importances can be encrypted using homomorphic encryption. The feature importances can be encrypted using secure aggregation. The ML algorithm is k-means clustering. The at least one processing device can be further configured to implement the following steps: determining the number ‘k’ of feature groups using an Elbow test. The at least one processing device can be further configured to implement the following steps: determining the number ‘k’ of feature groups using a Silhouette test. The subset of nodes can be selected based on measuring a correlation between the feature importances for a given node and a set of feature importances for the node group. The correlation can be measured using a rank biased overlap test. The correlation can be measured using a Kendall Ranking Correlation Coefficient test.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIGS. 1 and 2 disclose aspects of an example explainable federated learning framework, in accordance with illustrative embodiments.

FIG. 3 discloses a flowchart of an example method, in accordance with illustrative embodiments.

FIG. 4 discloses aspects of a computing entity configured and operable to perform any of the disclosed methods, processes, and operations, in accordance with illustrative embodiments.

### DETAILED DESCRIPTION

Example embodiments generally relate to machine learning and machine learning (ML) models. More specifically, at least some embodiments relate to systems, hardware, software, computer-readable media, and methods for understanding and identifying the relative importance of features in ML models used in edge networks.

Disclosed herein are techniques for explainable federated learning (FL). The disclosed techniques provide an explainable FL framework that is able to extract local models' explanations in terms of feature importances during training time and aggregate them into global models' explanations in a secure manner. Example embodiments exploit header matrices to compute local models' feature importances during training time and use the local models' explanations to: (i) compute global FL model's feature importances; and (ii) create a robust mechanism for FL applications in non-IID scenarios. Accordingly the disclosed techniques provide an explainable mechanism for client segregation and selection in FL frameworks that promotes robustness to heterogeneous scenarios and protects against potential malicious clients. The present FL solution uses an explainable mechanism based on feature importances for client aggregation and selection. This mechanism helps to create FL applications robust to non-IID scenarios while promoting explainability to the global and local FL models without adding much computational complexity. Moreover, using this explainable mechanism, the present FL framework also defends the global FL model against potential malicious clients that manipulate their local models during the learning process (e.g., deliberately seeking to sabotage the global FL model's performance).

Federated Learning (FL) is one of most promising distributed ML frameworks to strengthen data privacy and security by training locally and then aggregating local models into a global model without ever sharing their data. Therefore, due to data privacy constraints, it is not possible to guarantee data homogeneity of FL applications, such as within real-world scenarios. Concomitantly, the data heterogeneity issues impair the model's performance and hinder the model's convergence speed (i.e., more training rounds), which makes this problem one of the most relevant challenges in implementing effective FL solutions. In this context, improving the convergence speed by properly handling non-independent and identically distributed (non-IID) data is helpful to address the communication overhead, which is a bottleneck of FL frameworks. Furthermore, considering critical applications for real-world problems, it is helpful to balance conflicting goals in terms of performance, privacy-preservation, and interpretability. With that in mind, there are opportunities in providing explainable FL solutions that are robust to scenarios with non-IID (heterogeneous) data, which are common in real-world problems and can improve FL solutions available to clients and/or performed internally.

A critical application such as but not limited to healthcare is characterized by heterogeneous and geographically dispersed edge nodes and strong constraints in terms of privacy, interpretability, and efficiency (with respect to a model's performance, local computation, and communication power). Therefore, what is needed is efficient mechanisms able to provide interpretability and properly handle non-IID data in FL frameworks. Considering the distributed characteristic and strict privacy and communication constraints of FL applications, conventional Explainable Artificial Intelligence (XAI) approaches are not well suited for FL solutions. In this context, Explainable Federated Learning (XFL), also referred as interpretable FL, emerged as a research topic to address the explainability requirements in federated applications, attracting significant interest from academia and industry in recent years. Nonetheless, there is a need in providing explainable solutions that are robust to non-IID data while considering the data privacy, computation, and communication constraints of FL scenarios. Disclosed herein are robust and explainable FL approaches, as discussed in further detail herein.

Different from conventional XAI techniques, XFL solutions must deal with data privacy and resource constraints in terms of local computation and communication power, making explainability in the context of FL particularly challenging. XFL comprises, for example, solutions that are able to explain prediction results and client/feature selection considering the FL scenarios' constraints. In particular, proper client selection can directly impact the FL model performance since the quality of clients' local data can determine the effectiveness of their local models and consequently the performance of the global model as well. For example, clients with noisy data will probably negatively impact the FL model performance. Moreover, malicious clients can try to twist or manipulate their local models in order to sabotage the global FL model performance. In this context, extracting explanations during training time and providing the interpretation in terms of feature importance and client selection are helpful to promote explainability of the global models and then create an efficient and explainable FL framework.

The following describe advantages of the disclosed explainable federated learning framework:
1. The disclosed techniques provide an explainable FL framework that is able to extract local models' explanations in terms of feature importances during training time and aggregate them into global models' explanations in a secure manner. The present FL solution exploits a technique able to compute local models' feature importances during training time and use the local models' explanations to: (i) compute global FL model's feature importances; and (ii) create a robust mechanism for FL applications in non-IID scenarios.
2. The disclosed techniques provide an explainable mechanism for client segregation and selection in FL frameworks that promotes robustness to heterogeneous scenarios and protects against potential malicious clients. The present FL solution uses an explainable mechanism based on feature importances for client aggregation and selection. This mechanism helps to create FL applications robust to non-IID scenarios while promoting explainability to the global and local FL models without adding much computational complexity. Moreover, based on this explainable mechanism, the present FL framework also defends the global FL model against potential malicious clients that manipulate their local models during the learning process (e.g., deliberately seeking to sabotage the global FL model's performance).

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

Conventional solutions employ post-hoc (e.g., an additional operation after training is required to generate explanations) perturbation-based XAI algorithms such as SHAP values (SHapley Additive explanations) to compute feature importances detached from the federated training process, and/or presume the availability of a shared and public dataset to provide interpretation during the model aggregation phase. There are several issues associated with these conventional approaches. The following are some highlighted drawbacks of conventional solutions:
1. Conventional solutions assume availability of a shared public dataset, which might not be always possible to find in practice (due to privacy restrictions, for example).
2. The public dataset may not reflect the dynamicity/reality of the edge devices' scenarios present in the federation (usually containing non-IID data), which may lead to highly inaccurate interpretations.
3. Extracting explanations using a post-hoc technique results in a computation overhead at the edge nodes and also at the cloud, which can limit its application due to edge resource constraints and it can also become prohibitively costly as the number of FL participants grows.

The following sections present a brief introduction to some helpful concepts that are relevant to better comprehend the disclosed techniques, such as FL, XAI, and header matrices.

### A.1. Federated Learning

FL is a distributed ML framework to strengthen data privacy and security by training locally and then aggregating local models into a global model without needing to share the local data. In a conventional FL framework, the training process occurs distributed at the edge, and learns a shared model by aggregating locally computed updates, e.g., a central server is configured to update the global model based on the local models trained at the edge (for example, using a federated average algorithm, such as but not limited to FedAVG). Nonetheless, the heterogeneous nature of this procedure due to multiple distributed clients in the federation makes this goal especially challenging.

Data heterogeneity impairs the model's performance convergence speed (e.g., requiring more training rounds), which makes this technical problem one of the most relevant challenges in implementing effective FL solutions. In this context, improving the convergence speed by properly handling non-IID data is helpful to address the communication overhead, which is a bottleneck of conventional FL frameworks. Concomitantly, considering critical applications of real-world domains such as healthcare, it is helpful to balance conflicting goals in terms of performance, privacy-preservation, and interpretability. In this regard, XAI mechanisms for FL applications are useful to enable explainability to FL frameworks.

Advantageously, the disclosed techniques provide an explainable FL framework that is robust to non-IID scenarios. The next section introduces XAI in the context of FL.

### A.2. Explainable Artificial Intelligence in Federated Learning

XAI methods can generally be divided in two main categories: model-agnostic methods and interpretable models. Model-agnostic methods separate explanations from the ML model and provide explanations for the features used in the model training. This category is usually based on data perturbation. More specifically, the explanations indicate how much each feature contributes to the model's prediction. Interpretable models generate trackable information regarding how the model achieves a particular result (e.g., trained parameters of generalized linear models). The interpretability of explanations are restricted to specialists able to understand, for example, the parameters of a regression.

XAI helps promote explainability of the global model trained in FL applications. Nonetheless, conventional XAI techniques assume the availability and possibility of a centralized process to extract the model's explanations, which is not adequate for distributed ML framework such as FL. In this sense, XFL has become an emerging research topic, attracting significant interest from academia and industry in recent years. XFL solutions comprise, for example, FL frameworks that are able to explain prediction results and feature selection, support model debugging, and/or provide insights into contributions made by individual data owners (which is helpful to provide a fair reward allocation and to promote active and reliable participation in the federation) while considering the distributed characteristic of an FL framework.

When compared to XAI approaches, XFL is considerably more challenging since XAI solutions generally focus on centralized machine learning. In the case of FL applications, in order to minimize local computation constraints, it is helpful to provide efficient mechanisms to extract the model's explanations during training time (e.g., header matrices). However, there is a gap in providing explainable solutions that are robust to non-IID data while considering data privacy and computation/communication constraints of FL scenarios.

Advantageously, the disclosed techniques provide an explainable FL framework that offers technical solutions to the above-identified technical problems.

### A.3. Header Matrices

Header matrices are a technique able to determine relative feature importance during training time in artificial neural networks (ANNs) with low space and time complexity. In terms of space complexity, this technique merely requires that the ANN stores two (n×n) matrices (e.g., a header matrix and an accumulator matrix), where n is the number of input features. The overall computational complexity is O(N), where N is the number of epochs for model training. In this case, for each epoch it will add: (i) one attribution operation to set the header matrix as the identity matrix (n×n); (ii) one sum of two matrices (n×n), which corresponds to the accumulation step performed at the end of each full backpropagation; and (iii) one subtraction of two matrices (n×n), which corresponds to the recall of the identity values introduced by the header matrix at the beginning of each forward step.

More particularly, in some embodiments a high-level overview of using header matrices can be described as follows:
1. Introduce a header matrix (e.g., an identity matrix) of size (n×n) as the first layer of a neural network (e.g., prepend the header matrix) to participate in forward-feed and back propagation
2. Following backpropagation, use an accumulation matrix of size (n×n) to accumulate the adjusted weights (e.g., gradients) in the header matrix. In some implementations, the data added to the accumulation matrix is obtained by subtracting the header matrix after the backpropagation and the identity matrix prior to the forward feed, which corresponds to recalling the identity values introduced by the header matrix at the beginning of each feed forward step
3. Before each forward feed, reset the header matrix to the identity matrix

Accordingly, example embodiments are able to use header matrices to compute feature importances in ANNs without adding much computational complexity. Further detail regarding header matrices is disclosed in U.S. patent application Ser. No. 17/660,144 entitled “USING HEADER MATRICES FOR FEATURE IMPORTANCE ANALYSIS IN MACHINE LEARNING MODELS” and filed Apr. 21, 2022, the entire contents of which are incorporated by reference herein for all purposes.

The disclosed techniques adapt and exploit the benefits of header matrices to provide an explainable FL framework that is robust against scenarios with non-IID data and potential malicious clients. Section B herein provides further details on the present explainable FL framework.

### B. Overview of Aspects of an Example Embodiment

Disclosed herein is a FL framework operable to address the aforementioned limitations of conventional FL solutions. The present FL framework is capable of handling scenarios with non-IID data and potential malicious clients while providing explanations to the local and global models. Example embodiments are particularly useful for, but not limited to, critical domains such as healthcare. The disclosed techniques provide numerous benefits, including but not limited to, robustness, explainability, and security:
Robustness: disclosed herein is an effective client segregation/selection mechanism for FL model aggregation that provides robustness for FL applications in scenarios with heterogeneous data.
Explainability: the present model aggregation mechanism is an explainable AI-based solution that is able to securely extract global and local FL models' explanations, in terms of feature importances.
Security: the client segregation and selection mechanisms in the present FL framework promote robustness against non-IID data and protects the FL application against malicious clients.

Example embodiments exploit the usage of in-training feature importance extraction to remove the conventional need for a public dataset and avoid excessive computation overhead at the edge/cloud raised by conventional post-hoc XAI techniques. Also, based on computed feature importances, the disclosed techniques provide client segregation and trustworthiness-based client selection mechanisms that are able to provide global interpretability and robustness against scenarios with non-IID data and malicious attacks in FL applications. Although the present disclosure includes the relevance and benefits of using in-training feature importance extraction in some implementations, the client segregation and selection mechanisms leveraged in the framework are agnostic to particular type and implementation of explainable Al technique. Phrased differently, both in-training and post-hoc XAI techniques can be employed, without departing from the scope of the disclosed embodiments.

Example embodiments leverage header matrices to determine relative feature importance during training time in ANNs without adding much computational complexity at the edge side. Advantageously, since the feature importances are computed during training time, the disclosed techniques do not require storing a dataset to extract the local model's feature importances in a post-hoc fashion. These characteristics make header matrices a technique well suited for computing feature importances in FL applications without requiring a public dataset, without generating excessive computation overhead, and without compromising users' privacy. As discussed, section A.3 provides further details including space and time complexity analyses for header matrices.

In example embodiments, the disclosed feature importance extraction and client segregation/selection proceed in three general phases, one phase at the edge nodes and two phases at the central server. These phases are described in further detail herein.

What is needed is an explainable FL solution that is able to provide explanations regarding the global model in a secure manner and deal with scenarios with non-IID and potential malicious clients. Furthermore, technical solutions are needed that are able to use local models' feature importances to dynamically assist client aggregation and selection in the federation without requiring extra computation after training at the edge nodes and without requiring a public dataset to compute the global FL model's feature importances.

The disclosed techniques provide an explainable FL framework that is able to extract explanations regarding the local and global FL models during the federated training process. Moreover, based on these explanations, the present FL framework employs a mechanism for client selection and segregation in the federation to provide robustness against scenarios with non-IID data and/or potential malicious clients, which is the case in several real-world use cases.

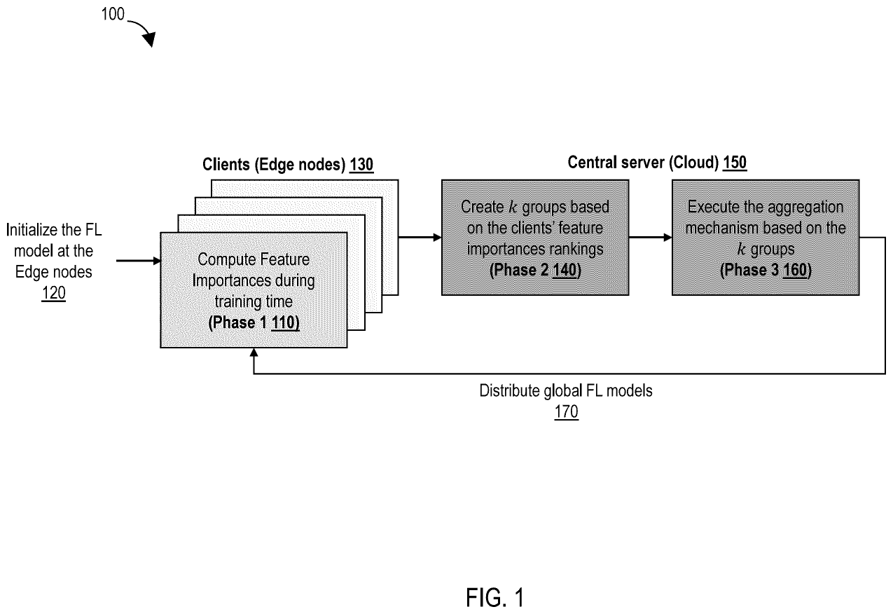

FIG. 1 shows aspects of an example explainable federated learning framework 100, in accordance with illustrative embodiments. In particular, FIG. 1 illustrates an overview of the explainable federated learning framework divided into three phases.

In example embodiments, phase 1 110 includes determining feature importances at training time. After the initial FL model is initialized and deployed 120 to the participating clients 130 (e.g., edge nodes), each edge node is configured to compute the local FL models' feature importances during training time at each client. Some embodiments compute the feature importances using in-training feature importance extraction. In further embodiments, the in-training feature importance extraction includes using header matrices, as discussed in further detail herein.

In example embodiments, the clients 130 are configured to communicate with the central server 150. Some embodiments of the edge nodes transmit feature importances to the central server. In further embodiments, the edge nodes receive a global FL model from the central server, for example to each edge node in a node group.

In example embodiments, phase 2 140 includes creating a number ‘k’ of node groups. In some implementations, phase 2 operates at the cloud side, for example at a central server 150 (sometimes referred to herein as a central node) in communication with the clients 130. In some embodiments, phase 2 uses a clustering technique (such as, by way of example and not limitation, k-means clustering). The central server creates a number k of node groups based on the feature importances ranking that the central server received from each client. In further embodiments, the value of k is a hyperparameter.

In example embodiments, phase 3 160 includes executing an aggregation mechanism. In some implementations, the aggregation mechanism uses the k groups. For example, the central server 150 creates a global FL model for each node group and distributes 170 the model to each client accordingly. The global FL model is sometimes referred to herein as a shared model. The FL proceeds to the next round (e.g., returning to phase 1 110).

### C. Detailed Description of Aspects of an Example Embodiment

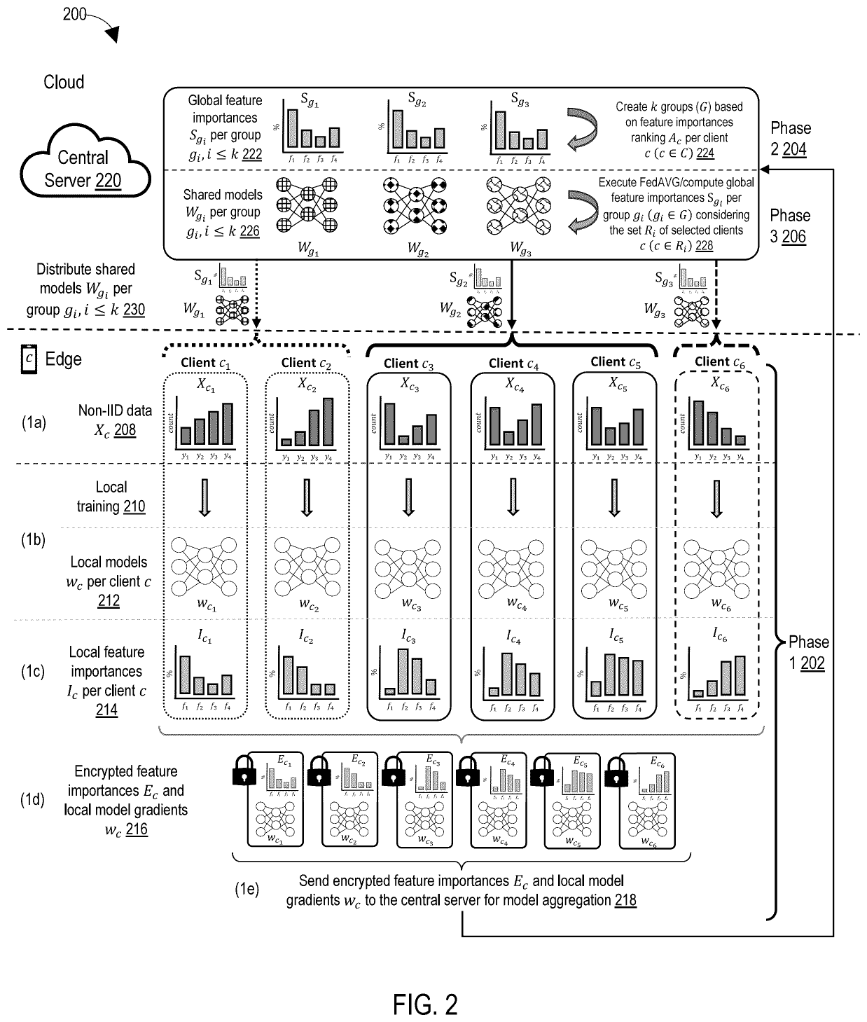

FIG. 2 shows aspects of an example explainable federated learning framework 200, in accordance with illustrative embodiments.

FIG. 2 shows phases 1, 2, and 3 202, 204, 206 considering an example scenario with non-IID data 208. The illustrated data includes X={X₁, X₂, X₃, X₄, X₅, X₆} (where the data used to train 210 each local model w per client 212 contains four features and the target variable y has four possible labels), a set C={c₁, c₂, c₃, c₄, c₅, c₆} with six clients (|C|=6), and a set G={g₁, g₂, g₃} containing three node groups (|G|=k, k=3). Sections C.1, C.2, and C.3 herein describe each phase in further detail.

### C.1 Phase 1

In example embodiments, Phase 1 202 (an example of phase 1 110) begins by distributing the initialized global model to all participating clients. Each client's edge node starts with an initialized FL model trained with a set F of features (set C of clients in the federation). Subsequently, each client trains its respective local model using its local data. Example local data can be independent and identically distributed (IID) random variables, or non-IID random variables.

Conventional use of feature importances for FL requires storing and processing a public dataset in order to compute the feature importances for the global model.

In contrast to conventional FL model training, the disclosed techniques exploit in-training feature importance extraction during the FL training mechanism. Advantageously, such in-training feature importance extraction allows the present federated learning to extract explanations without requiring a public dataset and while avoiding excessive computation overhead at the edge and cloud that would be raised by post-hoc explainable AI techniques. Some embodiments use header matrices in operation. As discussed, using header matrices refers to a technique that is able to determine relative importance between features during training time in ANNs without adding much computational complexity at the edge side.

More particularly, some embodiments of the header matrices technique only store two additional (|F|×|F|) matrices (e.g., a header matrix and an accumulator matrix), where |F| is the number of input features. The overall computational complexity is O(N), where N is the number of epochs for model training. Therefore, header matrices are well suited for constrained scenarios since (i) the technique does not require extra computation after training at edge nodes; the feature importances are computed during runtime, and (ii) there is no need to store a public dataset to compute the global model's feature importances. Instead, example embodiments use the local model's feature importances to compute the global model's feature importances during the model aggregation procedure (phase 3 206).

Advantageously, the computed feature importances help to provide interpretability for each edge node, and to dynamically perform aggregation and selection based on the computed explanation. This is relevant to: (i) create groups of similar clients and then provide a robust mechanism for the present FL framework applied in scenarios with non-IID data; (ii) provide interpretability for the local models and use it to extract explanations to the global FL model; (iii) use the local and global explanations to provide an explainable client selection mechanism when choosing clients that will participate in the current aggregation round, and avoiding malicious clients that can deliberately impair the FL model performance; and (iv) prioritize specific features to the detriment of others. These advantages are discussed in further detail in connection with Phases 2 204 and 3 206 herein (sections C.2 and C.3). It is also possible to employ encryption mechanisms, such as but not limited to homomorphic encryption, to provide a secure data sharing and global feature importance aggregation mechanism. In particular, this kind of encryption technique is especially useful for application domains with extreme privacy constraints.

An example embodiment of Phase 1 202 includes the following steps. FIG. 2 also shows these steps.
1. For each client c (c ϵ C):
   a. Each client c accesses its respective data X_{c} 208 (non-IID)
   b. Train 210 the local model w_{c} 212 using its data X_{c}
   c. During model training at the edge:
      i. Compute the feature importances I_{c} for each feature f (f ϵF) 214. Some embodiments compute the feature importances using an in-training feature importance extraction technique, such as but not limited to header matrices
      ii. Store the vector containing the feature importances, e.g., the relevance of each feature f (f ϵF)
   d. Encrypt the feature importances I_{c} 216. Some embodiments encrypt the feature importances using, but not limited to, homomorphic encryption or secure aggregation.
   e. Send the model gradients and encrypted feature importances E_{c} to the central server for model aggregation 218

### C.2 Phase 2

In example embodiments, Phase 2 204 (an example of phase 2 140) begins after receiving the gradients from the local models w_{c} and the respective encrypted feature importances vector E_{c} for each client c (c ϵ C). The central server 220 sorts (e.g., descending) all feature vectors in order to obtain a feature importances ranking vector A_{c}. In some implementations, this can be done by persisting the feature indexes during the sorting process. Subsequently, the central server creates k groups of clients based on their feature importance ranking vectors A_{c}. In some embodiments, the central server creates the k node groups by executing a clustering algorithm, such as but not limited to k-means clustering. FIG. 2 depicts an example scenario with six clients and the value of k is 3, where each of these groups are illustrated in short dashed lines (clients c₁, c₂), solid lines (clients c₃, c₄, c₅), and long dashed lines (client c₆), respectively. The central server will execute the model aggregation for each group, thereby creating k different shared models (in this example, three shared models). Section C.3 describes this procedure in more detail, herein.

An example high-level algorithm for Phase 2 is described as follows:
1. Start with the local model w_{c} gradients and encrypted feature importances E_{c} of each client c (c ϵ C)
2. For each client c (c ϵ C):
   a. Sort (e.g., descending) its feature importance vector E_{c}, preserving the feature indexes
   b. Obtain a ranking vector A_{c} (e.g., feature indexes ordered after sorting the vector E_{c})
3. Select n features, where n (n≤|F|) is a hyperparameter
4. Create a set G of k groups (|G|=k) of clients with similar feature ranking. Some embodiments us a clustering algorithm, such as but not limited to, k-means. In this case, k is a hyperparameter. Optionally, a recommended (e.g., optimal) number of clusters can be found using, for example but not limited to, the Elbow and/or Silhouette tests.

### C.3 Phase 3

In example embodiments, phase 3 206 (an example of phase 3 160) begins with a set G containing k groups of clients created during phase 2 204. Phase 3 can be divided in three general steps. For each node group, phase 3 will generally: (i) compute the global feature importances and create a ranking vector; (ii) compare the feature importance ranking vector of each client belonging in the group to the ranking vector of its respective group using, for example, a ranking correlation test, such as but not limited to an RBO (rank biased overlap) test. If a client is drifted when compared to its group, that client will not participate in the current aggregation round (nonetheless, that client will still receive the aggregated global model at the end of Phase 3); and (iii) compute the global feature importance for each group, create the shared FL models 228 (for example, by executing the FedAVG algorithm), and distribute the shared FL models to their respective clients 230.

An example high-level algorithm for Phase 3 206 can be described as follows:
1. Start with a set G containing k groups of clients
2. For each group gᵢ (gᵢ ϵG), i≤k:
   a. Compute the global feature importances S_{g}_{ᵢ}. In some embodiments, the global feature importances can be computed by determining an average feature importance considering all clients that are inserted into the node group
   b. Sort (e.g., descending) its feature importance vector S_{g}_{ᵢ}, preserving the feature indexes
   c. Obtain the ranking vector B_{g}_{ᵢ} (e.g., feature indexes ordered after sorting the vector S_{g}_{ᵢ})
   d. For each client cⱼ (cⱼ ϵgᵢ), j≤|gᵢ|:
      i. Compare its ranking A_{c}_{ⱼ} to its node group's global ranking B_{g}_{ᵢ} using a ranking correlation test or similarity measure between rankings, such as but not limited to Kendall Ranking Correlation Coefficient test and RBO
         1. If the computed coefficient z (0≤z≤1) for the client c is above a predetermined threshold t (0≤t≤1), include this client cⱼ in the set Rᵢ of clients. If not, include this client in the set R̅ᵢ. In some embodiments, the threshold t is a hyperparameter provided by a subject matter expert.
      ii. Store the computed coefficient in a time window T_{c}_{ⱼ} of size w, where w is a hyperparameter that determines the length of temporal context that will be stored. Example embodiments can use this temporal information for monitoring or analytics purposes.
   e. Considering only the selected clients cⱼ (cⱼ ϵRᵢ), j≤|Rᵢ|, Rᵢ∪R̅ᵢ=gᵢ:
      i. Compute the global feature importance for the group gᵢ
      ii. Train the shared FL model W_{g}_{ᵢ} for the group gᵢ. Example embodiments can train the shared FL model using a federated averaging algorithm, such as but not limited to FedAVG
   f. For each node group gᵢ (gᵢ ϵG), i≤k:
      i. Distribute the shared FL model W_{g}_{ᵢ} (gᵢ ϵG), i≤k and feature importances S_{g}_{ᵢ} for the group gᵢ to all selected clients

$${c}_{j} ( {c}_{j} ϵ {g}_{i} ) , 0 < j \leq \vert {g}_{i} \vert , {g}_{i} = {R}_{i} ⋃ {\overline{R}}_{i}$$

Advantageously, phases 1, 2, and 3 202, 204, 206 generally implement an explainable mechanism for client segregation and selection in FL frameworks based on feature importances for client aggregation or selection that promotes robustness to heterogeneous scenarios. Concomitantly, by providing a trustworthiness-based client selection mechanism, the disclosed techniques also defend the global FL model against potential malicious clients that manipulate the local models during the learning process in an effort to compromise the global model and sabotage the FL model's performance. Furthermore, saving the computed coefficients over a time window can be used to monitor potential threats in the global model performance. Together with the local model and global model explanations, this temporal drift monitoring can be used to execute preventive actions and/or create interpretable heuristics for client selection. This interpretability helps to avoid unfairness in the global FL model.

### C.4 Framework Benefits

In general, the present framework exploits in-training feature importance extraction in order to remove the conventional need for a public dataset and avoid excessive computation overhead at the edge or cloud. Based on the computed feature importances, the disclosed techniques provide a client segregation and trustworthiness-based client selection mechanisms that are able to provide global interpretability and robustness against scenarios with non-IID data and malicious attacks in FL approaches. Such client selection mechanisms can be particularly useful for, but are not limited to, critical domains such as healthcare.

Although the present disclosure has discussed the relevance and benefits of using in-training feature importance extraction at the edge devices, the disclosed client segregation and selection mechanisms are agnostic to the particular type of explainable AI technique. Phrased differently, the benefits of the disclosed client selection and segregation mechanisms can be leveraged in alternate embodiments using post-hoc explainable AI techniques in the present FL framework (for example, before model aggregation, in Phase 1). In the context of the disclosed embodiments, numerous benefits accrue to the present robust and explainable FL framework, which can be ported to a broad range of FL applications deployed at the edge.

### D. Example Methods

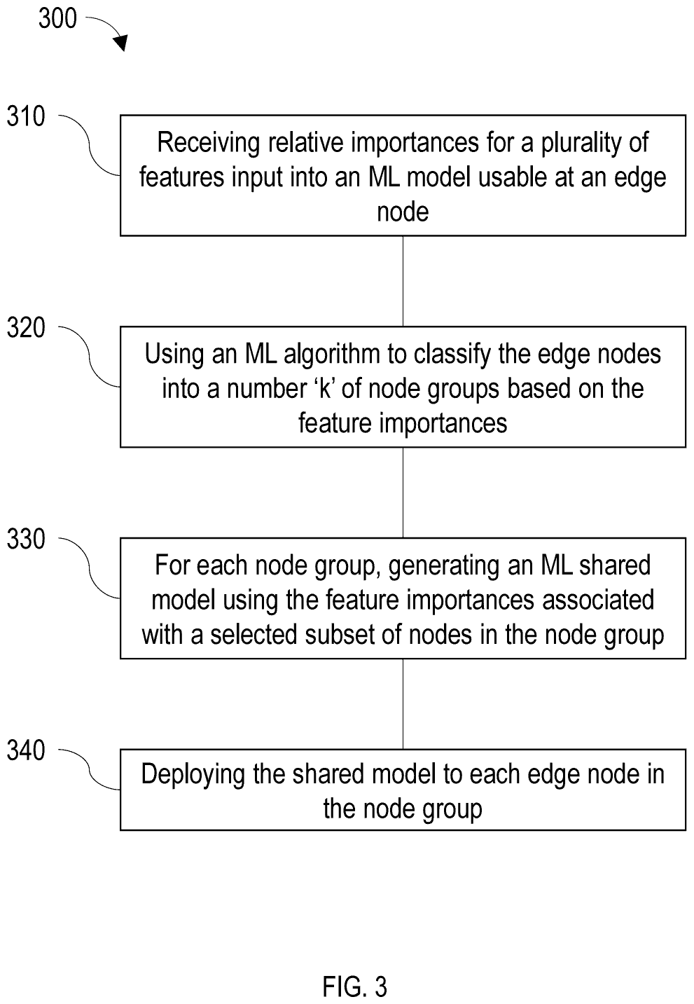

FIG. 3 shows a flowchart of an example method 300, in accordance with illustrative embodiments. In example embodiments, the method 300 allows for improved issue handling by identifying similar historical issues as references for a given issue.

In some embodiments, the method 300 can be performed by the present explainable FL solution 100, such as using the central server 150.

In example embodiments, the method 300 includes receiving relative importances for a plurality of features input into a ML model usable at an edge node, thereby defining a plurality of feature importances (step 310). In some embodiments, the central node can be configured to communicate with the edge nodes. In some embodiments, the feature importances are determined using in-training feature extraction. In further embodiments, the in-training feature extraction is performed using header matrices. In some implementations, the feature importances are encrypted and model gradients are also received. In some embodiments, the feature importances are encrypted using homomorphic encryption. In alternate embodiments, the feature importances are encrypted using secure aggregation.

In example embodiments, the method 300 includes using an ML algorithm to classify the edge nodes into a number ‘k’ of node groups based on the feature importances (step 320). In some embodiments, the ML algorithm is k-means clustering. In further embodiments, the number ‘k’ of feature groups is determined using an Elbow test. In alternate embodiments, the number ‘k’ of feature groups is determined using a Silhouette test.

In example embodiments, the method 300 includes, for each node group among the ‘k’ node groups, generating an ML shared model using the feature importances associated with a selected subset of nodes in the node group (step 330). In some embodiments, the subset of nodes is selected based on measuring a correlation between the feature importances for a given node and a set of feature importances for the node group. In some embodiments, the correlation is measured using a rank biased overlap test. In alternate embodiments, the correlation is measured using a Kendall Ranking Correlation Coefficient test.

In example embodiments, the method 300 includes deploying the shared model to each edge node in the node group (step 340).

While the various steps in the example method 300 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 300 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

At least portions of the present explainable FL system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present explainable FL system. For example, containers can be used to implement respective processing devices providing compute and/or storage services of a cloud-based system. Again, containers may be used in combination with other virtualization infrastructure such as virtual machines implemented using a hypervisor.

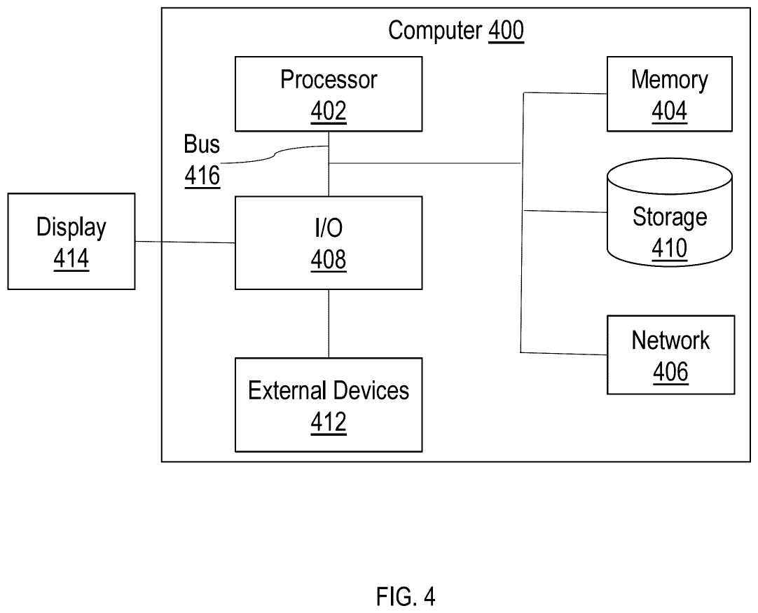

Illustrative embodiments of processing platforms will now be described in greater detail with reference to FIG. 4. Although described in the context of the present explainable FL system, these platforms may also be used to implement at least portions of other information processing systems in other embodiments.

FIG. 4 illustrates aspects of a computing device or a computing system in accordance with example embodiments. The computer 400 is shown in the form of a general-purpose computing device. Components of the computer may include, but are not limited to, one or more processors or processing units 402, a memory 404, a network interface 406, and a bus 416 that communicatively couples various system components including the system memory and the network interface to the processor.

The bus 416 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 400 typically includes a variety of computer-readable media. Such media may be any available media that is accessible by the computer system, and such media includes both volatile and non-volatile media, removable and non-removable media.

The memory 404 may include computer system readable media in the form of volatile memory, such as random-access memory (RAM) and/or cache memory. The computer system may further include other removable/non-removable, volatile/non-volatile computer system storage media. By way of example only, the storage system 410 may be provided for reading from and writing to a non-removable, non-volatile magnetic media (not shown and typically called a “hard drive”) in accordance with the present explainable FL techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 416 by one or more data media interfaces. As has been depicted and described in connection with FIGS. 1-3, the memory may include at least one computer program product having a set (e.g., at least one) of program modules that are configured to carry out the functions of the embodiments as described herein.

The computer 400 may also include a program/utility, having a set (at least one) of program modules, which may be stored in the memory 404 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 400 may also communicate with one or more external devices 412 such as a keyboard, a pointing device, a display 414, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 408. Still yet, the computer system may communicate with one or more networks such as a local area network (LAN), a general wide area network (WAN), and/or a public network (e.g., the Internet) via the network adapter 406. As depicted, the network adapter communicates with the other components of the computer system via the bus 416. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-4, any component described with regard to a figure, in various embodiments of the invention, may be equivalent to one or more like-named components described with regard to any other figure. For brevity, descriptions of these components has not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
at least one processing device including a processor coupled to a memory;
the at least one processing device being configured to implement the following steps:
receiving, at a central node, relative importances for a plurality of features input into a machine learning (ML) model usable at an edge node, thereby defining a plurality of feature importances, the central node being configured to communicate with the edge nodes;
using, at the central node, an ML algorithm to classify the edge nodes into a number ‘k’ of node groups based on the feature importances; and
for each node group among the ‘k’ node groups:
generating, at the central node, an ML shared model using the feature importances associated with a selected subset of nodes in the node group; and
deploying, at the central node, the shared model to each edge node in the node group.

2. The system of claim 1, wherein the feature importances are determined using in-training feature extraction.

3. The system of claim 2, wherein the in-training feature extraction is performed using header matrices.

4. The system of claim 1,
wherein the feature importances are encrypted, and
wherein the at least one processing device is further configured to implement the following steps:
receiving, at the central node, model gradients.

5. The system of claim 4, wherein the feature importances are encrypted using homomorphic encryption.

6. The system of claim 4, wherein the feature importances are encrypted using secure aggregation.

7. The system of claim 1, wherein the ML algorithm is k-means clustering.

8. The system of claim 7, wherein the at least one processing device is further configured to implement the following steps:
determining the number ‘k’ of feature groups using an Elbow test.

9. The system of claim 7, wherein the at least one processing device is further configured to implement the following steps:
determining the number ‘k’ of feature groups using a Silhouette test.

10. The system of claim 1, wherein the subset of nodes is selected based on measuring a correlation between the feature importances for a given node and a set of feature importances for the node group.

11. The system of claim 10, wherein the correlation is measured using a rank biased overlap test.

12. The system of claim 10, wherein the correlation is measured using a Kendall Ranking Correlation Coefficient test.

13. A method comprising:
receiving, at a central node, relative importances for a plurality of features input into a machine learning (ML) model usable at an edge node, thereby defining a plurality of feature importances, the central node being configured to communicate with the edge nodes;
using, at the central node, an ML algorithm to classify the edge nodes into a number ‘k’ of node groups based on the feature importances; and
for each node group among the ‘k’ node groups:
generating, at the central node, an ML shared model using the feature importances associated with a selected subset of nodes in the node group; and
deploying, at the central node, the shared model to each edge node in the node group.

14. The method of claim 13, wherein the feature importances are determined using in-training feature extraction.

15. The method of claim 14, wherein the in-training feature extraction is performed using header matrices.

16. The method of claim 13,
wherein the feature importances are encrypted,
further comprising receiving, at the central node, model gradients.

17. The method of claim 16, wherein the feature importances are encrypted using homomorphic encryption.

18. The method of claim 16, wherein the feature importances are encrypted using secure aggregation.

19. The method of claim 13, wherein the ML algorithm is k-means clustering.

20. A non-transitory processor-readable storage medium having stored thereon program code of one or more software programs, wherein the program code when executed by at least one processing device causes the at least one processing device to perform the following steps:
receiving, at a central node, relative importances for a plurality of features input into a machine learning (ML) model usable at an edge node, thereby defining a plurality of feature importances, the central node being configured to communicate with the edge nodes;
using, at the central node, an ML algorithm to classify the edge nodes into a number ‘k’ of node groups based on the feature importances; and
for each node group among the ‘k’ node groups:
generating, at the central node, an ML shared model using the feature importances associated with a selected subset of nodes in the node group; and
deploying, at the central node, the shared model to each edge node in the node group.
